(19) United States
(12) Patent Application Publication
(10) Pub. No.: US 2013/0220665 A1
(43) Pub. Date: Aug. 29, 2013

(54) MULTICORE ELECTRICAL CABLE AND METHOD OF MANUFACTURE

(71) Applicants: Siu Kit Joe Wong, Milnathort, (GB); Stephen Owen Mast, Panama City Beach, FL (US); Brett Kline, Houston, TX (US)

(72) Inventors: Siu Kit Joe Wong, Milnathort, (GB); Stephen Owen Mast, Panama City Beach, FL (US); Brett Kline, Houston, TX (US)

(73) Assignee: OCEANEERING INTERNATIONAL, INC., Houston, TX (US)

(21) Appl. No.: 13/405,111

(22) Filed: Feb. 24, 2012

(51) Int. Cl. H01B 7/17; H01B 13/20

(52) U.S. Cl. 174/116; 174/113 R; 29/828

(57) ABSTRACT

A multicore electrical cable comprises a substantially tubular insulating outer layer defining a common longitudinal axis therethrough with a plurality of insulated electrical conductors disposed therein, wound about the common longitudinal axis. Each insulated electrical conductor comprises a conductor core further comprising one or more conductor wire strands having a first non-conductive adhesive layer disposed about them. An insulating layer is disposed about the conductor core and a second non-conductive adhesive layer disposed within the substantially tubular outer layer into a void created between the wound plurality of insulated electrical conductors and the substantially tubular insulating outer layer.

### FIELD OF THE INVENTION

The present invention relates to the provision of an improved electrical cable with enhanced resistance to ingress of water or gas. More specifically, the cable is suitable for use subsea to provide electric power and/or signal transmission and may be used in umbilical conduits such as are used in offshore drilling environments.

### BACKGROUND OF THE INVENTION

In subsea working, such as offshore drilling environments, it is necessary to supply electrical power, electrical signals, optical signals, hydraulic controls, and/or fluids to subsea devices such as a wellhead. An umbilical is a conduit that can contain a number of functional elements for subsea work. Typically an umbilical comprises a group of functional elements such as electric cables, optical fiber cables, thermoplastic hoses or steel tubes. Cables, hoses, and/or tubes carried within an umbilical are generally of multilayer reinforced structures, such as are known in the art, configured to contain appropriate pressure and have burst and compression resistance for the envisaged usage. The umbilical provides a convenient single conduit to carry the fluid, electrical and signaling requirements of the task in hand.

### FIGURES

The figures supplied herein disclose various embodiments of the claimed invention.

FIG. 1 is a cutaway in partial perspective of an exemplary cable viewing a cross-sectional slice of the cable; and

FIG. 2 is a cutaway in partial perspective of an exemplary insulated electrical conductor viewing a cross-sectional slice of the insulated electrical conductor.

### DESCRIPTION OF EMBODIMENTS

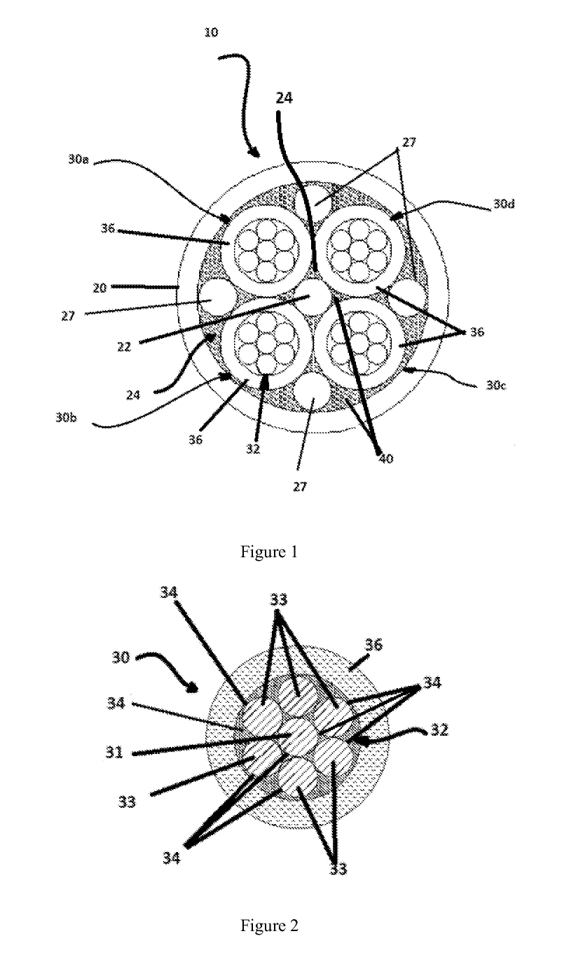

Referring to FIGS. 1 and 2, in an embodiment multicore electrical cable 10 comprises substantially tubular insulating outer layer 20, defining common longitudinal axis 22 therethrough; a plurality of insulated electrical conductors 30 (e.g., 30a, 30b, 30c, 30d) disposed within substantially tubular outer layer 20 and wound about common longitudinal axis 22; and second non-conductive adhesive layer 40 disposed within substantially tubular outer layer 20 into void 24 created between the wound plurality of insulated electrical conductors 30 and substantially tubular insulating outer layer 20. Typically, the plurality of insulated electrical conductors 30 disposed within substantially tubular outer layer 20 is helically wound about the common longitudinal axis 22. Although four insulated electrical conductors 30 are illustrated in FIG. 1, this is not a requirement and the number can vary as desired.

Referring more to FIG. 2, in a preferred embodiment, each insulated electrical conductor 30 comprises conductor core 32, itself further comprising a plurality of conductor wire strands 33 with first non-conductive adhesive layer 34 disposed about one or more conductor wire strands 33. First non-conductive adhesive layer 34 typically comprises a polyisobutene (PIB) based adhesive.

Insulating layer 36 is disposed about conductor core 32 and typically comprises a polymer, most typically a polyethylene polymer.

In a second contemplated embodiment, referring especially to FIG. 2, multicore electrical cable 10 is as described above. Note that only one conductor core 32 is called out in FIG. 1 but that each of the insulated electrical conductors 30 is configured similarly to that which is illustrated in FIG. 2. In the embodiment illustrated in FIG. 2, each insulated electrical conductor 30 comprises conductor core 32, each conductor core 32 typically comprising central wire strand 31 about which a plurality of conductor wire strands 33 are wound. The plurality of conductor wire strands 33 typically comprise at least six conductor wire strands 33 arranged around a single central wire strand 31. The plurality of conductor wire strands 33 are wound about central wire strand 31, e.g. helically.

First non-conductive adhesive layer 34 is disposed about one or more conductor wire strands 33 to fill the interstices between conductor wire strands 33 and central wire strand 31. In certain embodiments, first non-conductive adhesive layer 34 is also disposed within interstices defined between conductor wire strands 33 and insulating layer 36. Insulating layer 36 is disposed about first adhesive nonconductive layers 34.

In either embodiment, the plurality of insulated electrical conductors 30 may be wound about common longitudinal axis 22 helically, oscillatorily, or the like, or a combination thereof.

In either embodiment, additional filler materials may be present. In certain embodiments, solid filler 26 (not shown in the figures) may be disposed within void 24 in the substantially tubular insulating outer layer 20. Further, one or more filler rods 27 may be disposed within substantially tubular outer layer 20 adjacent to the wound plurality of insulated electrical conductors 30. As illustrated in FIG. 1, a filler rod 27 may be located along common longitudinal axis 22.

Thus, in most configurations no conductive sealant is used to manufacture multicore electrical cable 10. Instead, a non-conductive adhesive, such as non-conductive Oppanol B Type adhesive, may be used between the conductor wires and also between the stranded conductor and the insulation. Moreover, in most embodiments conductor core 32, including central wire strand 31 and conductor wire strands 33, are not compacted.

Referring still to FIGS. 1 and 2, in an exemplary process an insulated electrical conductor may be manufactured by forming an insulated electrical conductor 30. Insulated electrical conductor 30 made be formed by coating one or more conductor wire strands 33 with first non-conductive adhesive layer 34, then coating conductor wire strands 33 and non-conductive adhesive layers 34 with insulator 36. A plurality of insulated electrical conductors 30 may then be wound about common longitudinal axis 22 and the wound plurality of insulated electrical conductors 30 coated with second non-conductive adhesive layer 40 which may comprise an ethylene vinyl acetate (“EVA”) hot melt adhesive. An insulation layer 20, typically comprising a polymer, may be extruded onto the coated wound plurality of insulated electrical conductors 30.

In a second exemplary process, insulated electrical conductor 10 may be manufactured by forming a plurality of insulated electrical conductors 30 by coating a plurality of conductor wire strands 33 with non-conductive adhesive 34 and winding the plurality of coated conductor wire strands 33 about common central conductor strand 31. First non-conductive adhesive layer 34 is forced into interstices between the wound plurality of wire strands 33 and central conductor strand 31. In certain embodiments, first non-conductive adhesive layer 34 is also filled into the interstices between conductor strands 33 and insulating layer 36. A plurality of insulated electrical conductors 30 are then wound about common longitudinal axis 22 and the wound plurality of insulated electrical conductors 30 coated with a second non-conductive adhesive. As described above, second adhesive layer 42 may comprise an ethylene vinyl acetate (EVA) based hot melt adhesive. Substantially tubular insulating outer layer 20 may then be extruded onto the wound plurality of insulated electrical conductor 30, where substantially tubular insulating outer layer 20 comprises a polymer.

The foregoing disclosure and description of the inventions are illustrative and explanatory. Various changes in the size, shape, and materials, as well as in the details of the illustrative construction and/or an illustrative method may be made without departing from the spirit of the invention.

1) A multicore electrical cable, comprising:
a) a substantially tubular insulating outer layer defining a common longitudinal axis therethrough;
b) a plurality of insulated electrical conductors disposed within the substantially tubular outer layer and wound about the common longitudinal axis, each insulated electrical conductor comprising:
i) a conductor core, further comprising:
(1) a conductor wire strand; and
(2) a first non-conductive adhesive layer disposed about the conductor wire strand; and
ii) an insulating layer disposed about the conductor core; and
c) a second non-conductive adhesive layer disposed within the substantially tubular outer layer into a void created between the wound plurality of insulated electrical conductors and the substantially tubular insulating outer layer.

2) The multicore electrical cable of claim 1, further comprising a solid filler disposed within the void in the substantially tubular insulating outer layer.

3) The multicore electrical cable of claim 1, further comprising a filler rod disposed within the substantially tubular outer layer adjacent to the wound plurality of insulated electrical conductors.

4) The multicore electrical cable of claim 1, wherein the first insulation layer comprises a polymer.

5) The multicore electrical cable of claim 4, wherein the polymer comprises a polyethylene polymer.

6) The multicore electrical cable of claim 1, wherein the second non-conductive adhesive layer comprises an ethylene vinyl acetate (EVA) based hot melt adhesive.

7) The multicore electrical cable of claim 1, wherein the second non-conductive adhesive layer is further disposed between the insulated electrical conductors and the substantially tubular insulating outer layer.

8) The multicore electrical cable of claim 1, wherein the adhesive used in the first non-conductive adhesive layer comprises a polyisobutene (PIB) based adhesive.

9) The multicore electrical cable of claim 1, wherein the plurality of insulated electrical conductors disposed within the substantially tubular outer layer is helically wound about the common longitudinal axis.

10) A multicore electrical cable comprising:
a) a substantially tubular insulating outer layer defining a common longitudinal axis therethrough;
b) a plurality of insulated electrical conductors disposed about the common longitudinal axis within the substantially tubular outer layer, each insulated electrical conductor comprising:
i) a conductor core, further comprising:
(1) a central wire strand;
(2) a plurality of conductor wire strands wound about the central wire strand;
ii) a first non-conductive adhesive layer disposed within interstices defined between the conductor wire strands and the central wire strand; and
iii) an insulating layer disposed about the first non-conductive adhesive layer; and
c) a second adhesive layer disposed within the substantially tubular outer layer into a void created between the wound plurality of insulated electrical conductors and the substantially tubular outer layer.

11) The multicore electrical cable of claim 10, wherein the plurality of insulated electrical conductors are is wound at least one of (a) helically or (b) oscillatorily.

12) The multicore electrical cable of claim 10, further comprising a filler rod disposed within the substantially tubular outer layer adjacent to the wound plurality of insulated electrical conductors.

13) The multicore electrical cable of claim 10, further comprising a solid filler disposed within the void created between the wound plurality of insulated electrical conductors and the substantially tubular outer layer.

14) The multicore electrical cable of claim 10, wherein the first adhesive layer further comprises a portion disposed about an outer surface of the conductor wire strand.

15) The multicore electrical cable of claim 10, wherein the first insulation layer comprises a polymer.

16) The multicore electrical cable of claim 15, wherein the polymer comprises a polyethylene polymer.

17) The multicore electrical cable of claim 10, wherein the first adhesive layer comprises a polyisobutene (PIB) based adhesive.

18) The multicore electrical cable of claim 10, wherein the second adhesive layer comprises an ethylene vinyl acetate (EVA) based hot melt adhesive.

19) The multicore electrical cable of claim 10, wherein:
a) the plurality of conductor wire strands wound about the conductor core comprises at least six conductor wire strands arranged around a single central wire strand; and
b) the conductor wire strands are not compacted.

20) A process for the manufacture of a multicore electrical cable, comprising:
a) forming an insulated electrical conductor by:
i) coating a conductor wire strand with a non-conductive adhesive; and
ii) coating the conductor wire strand and its non-conductive adhesive with an insulator;
b) winding a plurality of insulated electrical conductors about a common longitudinal axis;
c) coating the wound plurality of insulated electrical conductors with a non-conductive adhesive layer; and
d) extruding a polymeric insulation layer onto the coated wound plurality of insulated electrical conductors.

21) A process for the manufacture of a multicore electrical cable, comprising:
a) forming an insulated electrical conductor by:
i) coating a plurality of conductor wire strands with a non-conductive adhesive;
ii) winding the plurality of coated conductor wire strands about a common central conductor strand;
iii) forcing a non-conductive adhesive into interstices between the wound plurality of wire strands; and
iv) coating the wound plurality of wire strands with an insulating layer;
b) winding a plurality of the insulated electrical conductors about common longitudinal axis;
c) coating the wound plurality of the insulated electrical conductors with a non-conductive adhesive; and
d) extruding a polymeric insulation layer onto the wound plurality of insulated electrical conductors.
